(19) United States
(12) Patent Application Publication
(10) Pub. No.: US 2009/0039173 A1
(43) Pub. Date: Feb. 12, 2009

(54) Method and apparatus for exemplary irrigation system

(76) Inventor: Neil Mammon, (US)

Correspondence Address: The Farrow Law Firm, Suite 500, 3031 Tisch Way, San Jose, CA, 95128, US

(21) Appl. No.: 11/890,439

(22) Filed: Aug. 6, 2007

(51) Int. Cl. B05B 12/12

(52) U.S. Cl. 239/11; 239/63; 239/69

(57) ABSTRACT

An automated irrigation system having a computer to monitor and regulate the water flow to the various destinations. The computer is user programmable. The water flow is regulated by solenoids which are open and close based upon the instructions received from the computer. Moisture sensors at the destination locations transmit information to the computer by a PC board to prevent water overflow or flooding.

### BACKGROUND OF THE INVENTION

This invention relates to an exemplary method and apparatus for an automated, non-farming irrigation system uniquely suited for watering indoor plants as well as outdoor lawns, hedges, plants, etc.

Today, there are no commercially available methods for watering indoor plants. Yet indoor plants are a staple both in and around residential and commercial buildings. However, keeping plants sufficiently watered exacts a cost in terms of time and money. In the residential building, the occupants are required to remember to manually water the plants, taking care not to over water or underwater the plants. Long periods of extended absences such as vacations can wreck havoc with indoor plants.

In commercial buildings, indoor plant maintenance is often relegated to a building employee who must be paid for this time. Moreover, this employee is not likely to know how often to water a given plant, and how much water to provide.

Similarly, outdoor plants, hedges, lawns, etc, generally receive no individualized attention when part of an automated system. Sprinklers are set to periodically provide water at regular intervals in fixed amounts regardless of the state of the plants. This often leads to the same issue of over watering or underwatering the plants.

### BRIEF SUMMARY OF THE INVENTION

The invention herein represents an exemplary solution to this problem which will save time and costs in the automation of water plants, both indoors and outdoors. Specifically, the invention consists of a main controller, one of more J Boxes, plumbing, and one or moisture sensor.

It is anticipated that this invention is ideally suited for new construction where the J Boxes can be installed into the structure of the building in the same way that electrical outlets are part of the structure of a building. This system is anticipated to cause a nominal increase in the cost of the building.

### BRIEF DESCRIPTION OF THE SEVERAL VIEWS OF THE DRAWINGS

FIG. 1 is a schematic illustration of the invention

FIG. 2 is a flow diagram of the invention

### DETAILED DESCRIPTION OF THE EMBODIMENTS

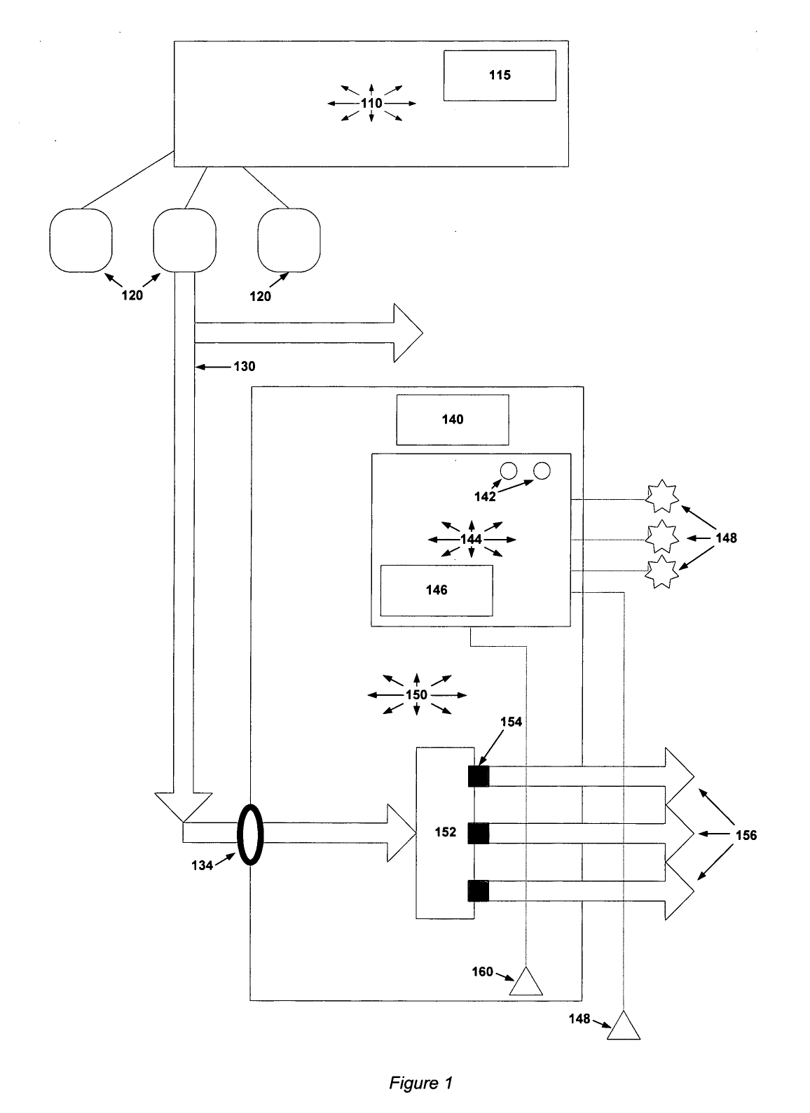

Referring to FIG. 1, FIG. 1 represents a high level schematic diagram of the invention. The invention is composed of main controller 110, which includes transmitter 115. Main Controller 110 controls the water flow through external water solenoid 120. Solenoid 120 is attached via PX tubing 130. PX tubing 130 is connected to one or more J Boxes 150. J Box 150 is comprised of Power Supply 140, and printed circuit board 144, which includes alarm lights 142, and transmitter 146. J Box 150 also includes water flow splitter 152, which directs the water flow equally to water solenoid 154. Leakage sensor 160 ensures sends and alert to circuit board 144.

Main controller 110 is a computer system capable of receiving data, processing said data, and outputting said data via one or more communications channel. For each J Box, the information received by Main Controller 110 would include, but is not limited to, how often to water each plant and how much water to provide each plant, and whether the watering amount and frequency, for a given plant, should depend on the moisture level of the soil. In one embodiment of the invention, main controller 110 has an interface configured to permit the user to input J Box control information directly to Main Controller 110. In another embodiment of the invention, instructions and data cannot be entered directly into Main Controller 110 by the user, but is received via a communications channel from each J Box 150. In yet a third embodiment of the invention, Main Controller 110 receives instructions and data from a computer network.

External Solenoid 120 is a common solenoid except that it can be controlled, i.e. opened and closed, by Main Controller 110. Its purpose is to permit or restrict water flow through PX tubing 130.

Printed Circuit Board 144 directly controls the opening and closing of Solenoid 154 which controls water flow to each plant. Printed Circuit Board 144 receives water moisture information from Moisture Sensors 148. Additionally, Printed Circuit Board 144 receives water leakage information from Moisture sensors 160.

In one embodiment of the invention, J Box 150 includes a method whereby the user can directly program water control information into Printed Circuit Board 144. This information would include, but is not limited to, how often to water the plants and how much water to provide each plant, and whether the watering amount and frequency should depend on the amount of moisture in the soil.

In another embodiment of the invention, the J Box receives this information from the main controller via a communications channel. In yet another embodiment, some information is received from Main Controller 110, while the remaining other information is set at each J Box 150.

Printed Circuit Board 144 uses this information to determine how long and how often to keep solenoid 154 open.

Moisture sensor 160 acts as a leakage control. In the presence of a leak, Moisture sensor 160 sends an interrupt to Printed Circuit Board 144. For purposes of this invention, an interrupt is a hardware signal that causes Printed Circuit Board 144 to set aside normal processing and begin execution of an interrupt handler, i.e. a special computer program associated with the interrupt. Upon receipt of the interrupt, Printed Circuit Board 144 closes Solenoid 154 and informs Main Controller 110 that Moisture sensor 160 detected a possible leak. Main Controller 110 will also close solenoid 120 as a further safeguard against leakage, until such time as it receives the all clear, i.e. the flag is reset.

In another embodiment of the invention, the Main Controller 110 opens and closed solenoid 120 based upon a set interval without regard to Moisture Sensor 160.

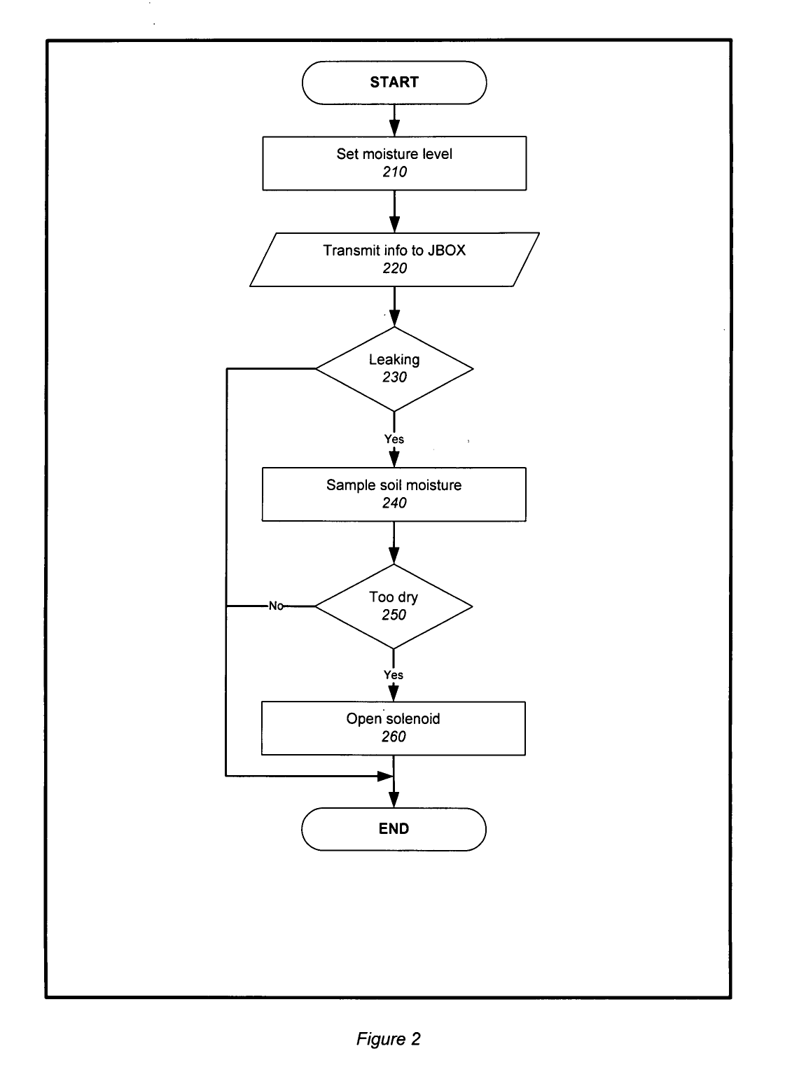

Referring to FIG. 2, FIG. 2 illustrates one embodiment of the flow logic of the invention. At step 210, the user sets the moisture level for a given plant. The moisture level is set at the main controller. At step 220, the moisture control information is transmitted to the appropriate J Box. In the preferred embodiment of the invention, the moisture control information is transmitted via radio frequency ID, although any wired or wireless protocol may be used to transmit the moisture control information.

At step 230, the main controller samples the leaking sensor. If the No_Leak sensor flag is set to Yes, it is considered a non-event. However, if the No-Leak Flag is set to No, then the solenoid remains closed and the routine ends.

At step 240, the main controller samples the soil moisture sensor. If the soil moisture level is below the programmed level then the SOIL_MOISURE_LEVEL flag is set to TOO DRY and the solenoid associated with said sensor will be opened for the programmed amount of time. If the SOIL_MOISURE_LEVEL flag is at or above the programmed level, the routine proceeds to END.

In another embodiment of the invention, the soil moisture level is programmed at each individual J Box.

In yet another embodiment of the invention, the main controller opens the solenoid without regard to the soil moisture level.

In a further embodiment of the invention, the invention includes an emergency shut-off button; said shut-off button would set the EMERGENCY_SHUTOFF flag as YES. IF the EMERGENCY-SHUTOFF flag is set to yes then the main controller will close the appropriate solenoid and will not permit it to be opened again until the EMERGENCY_SHUTOFF flag is set to no.

We claim:

1. An irrigation system comprising a main controller configured to accept user input, said main controller further configured to transmit information to a J BOX; one or more external solenoids configured to control the flow of water; said solenoids further capable of being electronically controlled; a J Box comprising a printed circuit board configured to receive and send information, a water solenoid configured to control water flow, one or more moisture sensors configured to determine soil moisture levels, one or more moisture sensors configured to determine leakage, and sufficient piping to carry water.

2. The main controller of claim 1 where the user input includes water moisture level.

3. The main controller of claim 1 where the user input includes watering duration.

4. The main controller of claim 1 where the main controller transmits and receives information wirelessly.

5. The main controller of claim 1 where the main controller transmits and receives information via wires.

6. The external solenoid of claim 1 where the solenoid is controlled by the main controller.

7. The printed circuit board of claim 1 where the circuit board receives soil moisture level from the moisture sensors.

8. The printed circuit board of claim 1 where the circuit board received leakage information from the leakage water sensor.

9. The printed circuit board of claim 1 where the circuit board receives and transmits information to the main controller.

10. The irrigation system of claim one further comprising a water tight seal.

11. The irrigation system of claim 1 further comprising an emergency shut-off button.

12. A method of automating the irrigation process comprising the steps of programming the main controller with the irrigation parameters; transmitting said information to the printed circuit within the J Box; obtaining the leakage information; obtaining the soil moisture level information; and opening and closing water solenoids

13. The method of claim 12 where the information programmed into the main controller includes the soil moisture level.

14. The method of claim 12 where the information programmed into the main controller includes the watering duration.

15. The method of claim 12 where the information is wirelessly transmitted from the main controller to the printed circuit.

16. The method of claim 12 where the information is transmitted from the main controller to the printed circuit via a wired connection.

17. The method of claim 12 where the leakage information is transmitted to the main controller.

18. The method of claim 17, where the main controller instructs the printed circuit not to open the water solenoid

19. The method of claim 12 where the printed circuit obtains the soil moisture level and transmits the soil moisture level to the main controller for instructions on whether or not to open the water solenoid.

20. The method of claim 12 where the printed circuit obtains the soil moisture level from the soil moisture sensors and determines whether to open the water solenoid.

21. The method of claim 12, further comprising the step of checking the status of the emergency shut-off flag.
